(19) United States
(12) Patent Application Publication
(10) Pub. No.: US 2023/0334298 A1
(43) Pub. Date: Oct. 19, 2023

(54) LEAK CHARACTERISATION METHOD

(71) Applicant: VEOLIA ENVIRONNEMENT, PARIS (FR)

(72) Inventors: Yannick DELEUZE, MAISONS-LAFFITTE (FR); Damien CHENU, ASNIERES-SUR-SEINE (FR); Nicolas ROUX, LA GARENNE-COLOMBES (FR)

(21) Appl. No.: 18/027,390

(22) PCT Filed: Sep. 23, 2021
(86) PCT No.: PCT/FR2021/051639

§ 371 Date: Mar. 21, 2023

(30) Foreign Application Priority Data
Sep. 25, 2020 (FR) FR2009791

(51) Int. Cl. G06N 3/047; G01M 3/26; G06N 3/08

(52) U.S. Cl. CPC G06N 3/047; G01M 3/26; G06N 3/08

(57) ABSTRACT

Method for characterizing a leak in a fluid network, the fluid network including several interconnected areas, in which the fluid network is equipped with at least one flow rate sensor at the inlet of the fluid network and with at least one other hydraulic sensor, of the flow rate or pressure sensor type, configured to provide hydraulic behavior data (Qi, Pi), in which the fluid network is provided with a digital mapping comprising at least the geometry of the fluid network and the location of said hydraulic sensors, and in which a statistical learning model receives as input a set of hydraulic behavior data (Qi, Pi) and provides as output at least one leak characterization data among the leak area (Zf) and the leak flow rate (Qf).

### CROSS REFERENCE TO RELATED APPLICATIONS

This application claims priority to PCT Patent Application No. PCT/FR2021/051639, filed Sep. 23, 2021 that in turn claims priority to French Patent Application No. FR2009791 filed Sep. 25, 2020, all of which are incorporated herein by reference.

### TECHNICAL FIELD

The present disclosure relates to a method for characterizing a leak in a fluid network, making it possible to detect and characterize a leak in a fluid network, particularly to determine its area and/or its flow rate.

Such a method may be used in particular to detect and characterize leaks within a water distribution network. However, it could also be used for gas, fuel networks or any other fluid, liquid or gaseous network. Such a method may also be applied to different sizes of networks.

### BACKGROUND

In France, the drinking water distribution networks present losses of about 20% on the national territory with sometimes losses that can locally reach nearly 40%. Other countries are experiencing even more worrying situations with local losses of up to 60%.

It is therefore essential to be able to detect and characterize the leaks present in a water distribution network in order to be able to prioritize the interventions and repair the thus detected leaks.

Several techniques exist so far in order to perform such detection. Among them, the vibro-acoustic listening and sectorization methods are the most widely used.

The vibro-acoustic listening methods aim at locally listening, using a microphone for example, to the signals emitted by the leaks in the pipes. Such a technique is quite effective but it requires a large number of listening points, that is to say a large number of sensors or, in the case of a mobile configuration, a full-time expert operator moving along the network, in order to cover the entire network. In addition, they are highly subject to acoustic disturbances from the environment of the pipes, for example road traffic. Finally, and especially, these methods allow locating the leaks but they do not allow characterizing them.

The sectorization methods for their part aim at sectorizing the network into small isolated areas and comparing the flow rates at the inlet and at the outlet of each area in order to detect the presence of a leak flow rate. However, such a method is not sufficient on its own since it does not allow locating quite precisely the location of the leak, particularly on a mesh network that would require too many sensors. In addition, the sectorization does not allow discriminating the severity of each leak when several leaks are present in the same sector. In any case, when an estimation of the severity is possible, this estimation can only be obtained a posteriori, after the repair of the leak, which prevents any prioritized maintenance.

In addition, such a water distribution network frequently presents multiple leaks of various types and severities. Particularly, the repair of some minor leaks is not always profitable or at least not always a priority. However, the current detection methods do not allow obtaining precise information as to the severity of the detected leak, which makes it difficult to set up a prioritized maintenance. There is therefore a need for a method for characterizing a leak in a fluid network, making it possible to detect and determine the area and/or the flow rate of a leak before its repair.

### DISCLOSURE OF THE INVENTION

The present disclosure relates to a method for training a statistical learning model intended for the characterization of a leak in a fluid network, the fluid network including several interconnected areas, in which the fluid network is equipped with at least one flow rate sensor at the inlet of the network and with at least one other hydraulic sensor, of the flow rate or pressure sensor type, configured to provide hydraulic behavior data, in which the fluid network is provided with a digital mapping comprising at least the geometry of the fluid network and the location of said hydraulic sensors, comprising the construction of a database containing a plurality of leak scenarios associating at least one leak characterization data among the leak area and the leak flow rate with a set of hydraulic behavior data, and a plurality of leak-free scenarios associating the “no leak” label with a set of hydraulic behavior data, and comprising the training of the statistical learning model on the thus constructed database.

Thanks to such a method, it is possible to build a database that may allow the statistical learning model, once trained on this database, to detect and characterize a leak in a fluid network based on a set of hydraulic behavior data obtained on the fluid network in question.

Naturally, the more the database contains a large number of scenarios, the more the training of the statistical learning model will be advanced and the more this statistical learning model will be capable of detecting and characterizing the leaks accurately. Particularly, the more the database contains varied scenarios, exploring as much as possible all the envisageable cases, the more the statistical learning model will manage to recognize these situations with ease and reliability.

On the other hand, a large number of hydraulic sensors may not be required to obtain satisfactory results. On the contrary, this method allows obtaining more precise and more reliable results than the existing sectorization methods, including in the presence of several distinct leaks.

In the present disclosure, the terms “area” and “detectability area” refer to a predefined group of pipes within the network or a sector when such sectors exist. In the present disclosure, identifying the location of one or more leaks aims at identifying the area containing the leak, without seeking a more precise location within said area. Moreover, as a function of the geometry of the network and of the location of the hydraulic sensors, some leaks may be indiscernable from each other by such hydraulic techniques if they are located on the same pipe or on some neighboring pipes: a detectability area is then said to be “minimal” if it is not possible to reduce its size without losing its indiscernable nature. Thanks to the present method, it is possible to define minimum detectability areas grouping only a few pipes, when the conventional sectorization methods can locate a leak only across a complete sector.

In the present disclosure, the term “sector” is meant as a subset of the fluid network provided with a flow rate sensor at each of its inlet or outlet interfaces, which thus allows making a consumption balance sheet across the sector and detecting water losses, in particular by studying the evolution of the night-time consumptions. In general, a fluid network comprises several sectors interconnected at a few crossing points, all these crossing points being therefore equipped with a flow rate sensor. Depending on the size of the fluid network, each sector generally comprises between 10 and 40 km or between about 6 and 25 miles of pipe. The present disclosure may then apply equally across the entire network or across each sector, when such sectors exist within the network.

In the present disclosure, the term “flow rate sensor” is disclosed as both a sensor capable of measuring the instantaneous flow rate of the fluid at the level of the sensor and a volume meter capable of measuring, incrementally, the volume of fluid passing through the sensor in a given direction and therefore is also capable of indirectly determining the average flow rate, over a given time interval, at the level of this sensor.

In some embodiments, the digital mapping of the network further comprises the network equipment and/or network delivery points.

In some embodiments, the fluid network is also provided with a digital model of the hydraulic behavior of the network including at least one nominal consumption scenario. This digital model allows for simulations of the hydraulic behavior of the network to be carried out by modifying some variables, for example requests of different consumers. This digital model also allows simulating leaks on some pipes of the network and calculating the hydraulic behavior of the network in the presence of these leaks, particularly at the level of the locations of the hydraulic sensors. These nominal consumption scenarios may form part of the leak-free scenarios recorded in the database with a “no leak” label.

In some embodiments, the digital model of the hydraulic behavior of the network includes several nominal consumption scenarios depending on the time of the day, the day the of week and/or the season. This allows more precise and more reliable simulations taking into account the temporality of the simulated situation. This also allows the statistical learning model to recognize the nominal leak-free situations, independently of the time of evaluation. Particularly, the day may be divided into two periods: the day and the night; however, a finer division of the day may also be used. Particularly, the week may be divided into two periods: the working days, from Monday to Friday, and the weekends, from Saturday to Sunday; however, a finer division of the week, for example taking into account each day of the week individually, may also be used. Particularly, the year may be divided into two periods: the summer period and the winter period; however, a finer division of the year, quarterly or monthly, may also be used; school holidays may also be taken into account.

In some embodiments, the database contains several robustness scenarios devoid of leaks but comprising noise. This allows enhancing the training of the statistical learning model and thus increasing the probability of correctly detecting a leak-free situation, in other words reducing the probability of false leak detection. Particularly, the noise addition may comprise the introduction of variations in the requests of the different consumers relative to the nominal consumption scenarios.

In some embodiments, the training method comprises a step of introducing a stochastic variability into the hydraulic behavior data recorded in the database for each leak scenario. This is also possible, and preferable, for the leak-free scenarios, as seen above with the robustness scenarios. The training of the statistical learning model is thus enhanced, which allows increasing its reliability. Particularly, for each original scenario, with or without a leak, several scenarios may be recorded in the database with different sets of stochastic offsets.

In some embodiments, the database contains at least one leak scenario simulated using the digital mapping of the network and the digital model of the hydraulic behavior of the network. This allows increasing the size of the database at will and, in particular, simulating a wide variety of situations, further enhancing the training of the statistical learning model. These leak scenarios comprise at least the hydraulic behavior data at the locations of the hydraulic sensors.

In some embodiments, the database contains at least one real leak scenario. Particularly, it is possible to record in the database all the leaks actually detected and characterized in the network, in association with the hydraulic behavior data collected during these leaks by the hydraulic sensors.

In some embodiments, the database contains at least 10,000 leak scenarios, preferably at least 100,000 leak scenarios, preferably at least 1,000,000 leak scenarios. The larger the size of the database, the more the training of the statistical learning model may be advanced and therefore the greater the accuracy and the reliability of the latter. Naturally, in order to reach such a volume of scenarios, it is preferable to include both real leaks and simulated leaks.

In some embodiments, the database contains at least several leak scenarios relating to different times of the day, days of the week and/or seasons. Particularly, the database may record for each of these scenarios a label recalling the corresponding time of the day, week and/or year. However, such labeling is in no way essential to allow the detection and the characterization of leaks by the statistical learning model: in practice, this information may not be given to the statistical learning model.

In some embodiments, each scenario includes at least one time series of sets of hydraulic behavior data. This allows increasing the amount of data that may be analyzed by the statistical learning model and overcoming some transient events within the hydraulic network, such as sudden variations in the requests of certain consumers.

In some embodiments, the time series extends over at least 4 hours, preferably at least 8 hours, more preferably 24 hours.

In some embodiments, the step of the time series is less than or equal to 60 minutes, preferably less than or equal to 30 minutes, more preferably less than or equal to 15 minutes.

In some embodiments, at least one leak scenario includes several leaks with characterization data of each of these leaks. This allows training the statistical learning model to recognize situations in which several leaks are present, which current sectorization methods do not allow. The statistical learning model, once trained, may then detect such a multi-leak situation but also determine the area and/or the flow rate of each leak thus detected.

In some embodiments, at least one leak scenario includes at least three distinct leaks, preferably at least four distinct leaks, more preferably at least five distinct leaks.

In some embodiments, an area of the fluid network comprises a maximum of 3,000 meters of pipe, preferably a maximum of 1,000 meters of pipe, more preferably a maximum of 500 meters of pipe and more preferably a maximum of 150 meters of pipe.

In some embodiments, a fluid network area comprises a length of pipe less than 30%, preferably less than 20%, more preferably less than 10%, of the length of pipe in the sector.

In some embodiments, the fluid network comprises at least one sector, each sector including a plurality of areas and at least one flow rate sensor at the inlet of the sector. When the network comprises several sectors, a flow rate sensor is provided at the interface between each interconnected sector. On the other hand, a flow rate sensor is not required between the different areas of the same sector.

In some embodiments, the hydraulic sensors comprise at least one flow rate sensor and at least one pressure sensor.

In some embodiments, the flow rate sensors represent a part among the hydraulic sensors of less than 50%, preferably less than 20%, more preferably less than 10%. Thanks to the present method, it is indeed possible to reduce the use of the flow rate sensors: indeed, with the exception of the flow rate sensor provided at the network or sector inlet, pressure data are sufficient for the operation of the present method. This is advantageous because the pressure sensors are less expensive and easier to set up and maintain than the flow rate sensors.

In some embodiments, the pressure sensors represent a part among the hydraulic sensors greater than 50%, preferably greater than 80%, more preferably greater than 90%.

In some embodiments, the network comprises at least 1 hydraulic sensor for 3,000 meters of pipe, preferably for 2,000 meters of pipe, more preferably for 1,000 meters of pipe.

In some embodiments, the training method comprises an optimized sensor placement step, during which at least one optimized location is determined for at least one new hydraulic sensor. This allows optimizing the cost-effectiveness ratio of the introduction of any new sensor.

In some embodiments, the optimized sensor placement step comprises the following steps: simulating several potential hydraulic sensors at different locations in the fluid network; simulating several leak scenarios; and identifying the potential sensors that maximize the probability of detection of the leaks and/or that maximize the discernibility of the detected leaks. In the present disclosure, it is considered that two leaks are discernible when the set of sensors of the network returns signatures, that is to say sets of measurements that are different from each other. Thus, indirectly, maximizing the discernibility of the leaks allows reducing the size of the areas Z. In order to maximize the efficiency of this method, it is possible to vary both the location of the simulated leaks and also their flow rates; it is also possible to compare the results with several nominal scenarios.

In some embodiments, the training method comprises a step of defining the areas of the fluid network, during which at least one area is defined to optimize the detection of leaks by the hydraulic sensors. Particularly, the objective is to be able to minimize the size of the areas but also, for an equal area size, to increase the probability of distinguishing two neighboring leaks.

In some embodiments, the training method comprises a step of calibrating the digital model of the hydraulic behavior of the network, during which at least one parameter of the digital model of the hydraulic behavior of the network is adjusted by comparing a simulated scenario with the corresponding real scenario. This allows in particular improving the accuracy of the digital model when the distribution network is modified or when evolutions in the consumption profiles are expected. In any event, the inventors have observed that the present method may not require a very precise calibration of the digital model of the hydraulic behavior of the network.

In some embodiments, the step of calibrating the digital model of the hydraulic behavior of the network comprises the use of an optimization algorithm minimizing the error between the simulated data of the simulated scenario and the measured data of the corresponding real scenario.

In some embodiments, the statistical learning model comprises at least one neural network.

In some embodiments, the neural network is a fully connected convolutional network of the classifier type comprising three convolutional layers of time filters. The layers of the neural network contain time filters of a size between 1 and 4 hours. The convolutional layers are organized such that the number of filters increases with the second layer, decreases with the last layer for the final estimation. To avoid the overlearning, the abandonment technique is used.

In some embodiments, the statistical learning model is a decision tree model, a support vector machine or a non-linear regression.

In some embodiments, the statistical learning model is of the classifier type. In other words, the leak flow rate is determined among predetermined flow rate ranges. These ranges may have constant or variable widths. Preferably, the width of each range is less than or equal to 10 m³/h, more preferably less than or equal to 5 m³/h.

In some embodiments, the statistical learning model is of the regressor type. In other words, the leak flow rate is determined as accurately as possible, with a certain margin of error. Preferably, this margin of error relative to the real leak flow rate is less than or equal to 10% or less than or equal to 10 m³/h or 5 m³/h.

The present disclosure also relates to a method for characterizing a leak in a fluid network, the fluid network including several interconnected areas, in which the fluid network is equipped with at least one flow rate sensor at the inlet of the network and with at least one other hydraulic sensor, of the flow rate or pressure sensor type, configured to provide hydraulic behavior data, in which the fluid network is provided with a digital mapping comprising at least the geometry of the fluid network and the location of said hydraulic sensors, and in which a statistical learning model receives as input a set of hydraulic behavior data and provides as output leak characterization data among the leak area and the leak flow rate.

Thus, thanks to such a statistical learning model, it is possible to detect a leak and obtain information on its area and/or its flow rate, that is to say its severity. In addition, this estimation may be done remotely. The characterization method is also capable of concluding that there is no leak if, during the analysis of the hydraulic behavior data, the statistical learning model does not detect any leak.

Consequently, thanks to such a method, it is possible to prioritize the repairs to be conducted within the fluid network, which optimizes maintenance costs and therefore increases the overall performance of the fluid network.

In some embodiments, the statistical learning model has been trained using a training method according to any one of the embodiments described above.

In some embodiments, the digital mapping of the network further comprises the equipment of the networks and/or the delivery points of the network.

In some embodiments, the statistical learning model receives as input at least one time series of sets of hydraulic behavior data.

In some embodiments, the time series extends over at least 4 hours, preferably at least 8 hours, more preferably 24 hours.

In some embodiments, the step of the time series is less than or equal to 60 minutes, preferably less than or equal to 30 minutes, more preferably less than or equal to 15 minutes.

In some embodiments, when the statistical learning model detects several leaks, it outputs at least one characterization data of each detected leak.

In some embodiments, an area of the fluid network comprises a maximum of 3,000 meters of pipe, preferably a maximum of 1,000 meters of pipe, more preferably a maximum of 500 meters of pipe and more preferably a maximum of 150 meters of pipe.

In some embodiments, a fluid network area comprises a length of pipes less than 30%, preferably less than 20%, more preferably less than 10%, of the length of the pipes of the sector.

In some embodiments, the fluid network comprises at least one sector, each sector including a plurality of areas and at least one flow rate sensor at the inlet of the sector. When the network comprises several sectors, a flow rate sensor is provided at the interface between each interconnected sector. On the other hand, a flow rate sensor is not required between the different areas of the same sector.

In some embodiments, the hydraulic sensors comprise at least one flow rate sensor and at least one pressure sensor.

In some embodiments, the flow rate sensors represent a part among the hydraulic sensors less than 50%, preferably less than 20%, more preferably less than 10%.

In some embodiments, the pressure sensors represent a part among the hydraulic sensors greater than 50%, preferably greater than 80%, more preferably greater than 90%.

In some embodiments, the statistical learning model comprises at least one neural network.

In some embodiments, the neural network is a fully connected convolutional network of the classifier type comprising three convolutional layers of time filters. The layers of the neural network contain time filters of a size between 1 and 4 hours. The convolutional layers are organized such that the number of filters increases with the second layer, decreases with the last layer for the final estimation. To avoid the overlearning, the abandonment technique is used.

In some embodiments, the statistical learning model is a decision tree model, a support vector machine or a non-linear regression.

In some embodiments, the statistical learning model is of the classifier type. In other words, the leak flow rate is determined among predetermined flow rate ranges. These ranges may have constant or variable widths. Preferably, the width of each range is less than or equal to 10 m³/h, more preferably less than or equal to 5 m³/h.

In some embodiments, the statistical learning model is of the regressor type. In other words, the leak flow rate is determined as accurately as possible, with a certain margin of error. Preferably, this margin of error relative to the real leak flow rate is less than or equal to 10% or less than or equal to 10 m³/h or 5 m³/h.

The present disclosure also relates to a module for characterizing a leak in a fluid network, the fluid network including several interconnected areas, the fluid network being equipped with at least one flow rate sensor at the inlet of the network and with at least one other hydraulic sensor, of the flow rate or pressure sensor type, configured to provide hydraulic behavior data, the fluid network being provided with digital mapping comprising at least the geometry of the fluid network and the location of said hydraulic sensors, comprising a statistical learning model configured to receive as input a set of hydraulic behavior data and to provide as output at least one leak characterization data among the leak area and the leak flow rate.

The advantages of this characterization module stem from the advantages described above for the characterization method. In addition, this characterization module may present all or part of the additional characterizations described above concerning the training method and/or the characterization method.

In some embodiments, the leak characterization module comprises an optimized sensor placement module configured to determine an optimized location for at least one new hydraulic sensor.

In some embodiments, the leak characterization module comprises a module for defining the areas of the fluid network, configured to define at least one area that allows optimizing the leak detection by the hydraulic sensors.

In some embodiments, the leak characterization module comprises a module for calibrating the digital model of the hydraulic behavior of the network, configured to adjust at least one parameter of the digital model of the hydraulic behavior of the network by comparing a simulated scenario with the corresponding real scenario.

The present disclosure also relates to a fluid network, comprising a plurality of hydraulic sensors, of the flow rate or pressure sensor type, configured to provide hydraulic behavior data, and a characterization module according to any one of the embodiments described above.

The present disclosure also relates to a computer program comprising instructions for the execution of the steps of the training method or of the characterization method described above when the program is executed by at least one computer.

The aforementioned characteristics and advantages, as well as others, will become apparent upon reading the following detailed description of exemplary embodiments of the proposed training method, characterization method and characterization module. This detailed description refers to the appended drawings.

### BRIEF DESCRIPTION OF THE DRAWINGS

The appended drawings are schematic and primarily intended to illustrate the principles of the disclosure.

In these drawings, from one figure to another, identical elements (or parts of elements) are identified by the same reference signs.

FIG. 1 is an overall diagram of a fluid network equipped with a leak characterization module;

FIG. 2 is an overview diagram of a leak characterization module;

FIG. 3 illustrates an example of a neural network training; and

FIG. 4 illustrates an example of a leak characterization using this neural network.

### DESCRIPTION OF THE EMBODIMENTS

Examples of training methods, characterization methods and characterization modules are described in detail below, with reference to the appended drawings. It is recalled that the invention is not limited to these examples.

FIG. 1 represents a diagram of a fluid network 1, in this case a drinking water distribution network. This fluid network 1 has a plurality of pipes 2 connecting a plurality of nodes 3. The nodes 3 are thus branching points between several pipes 2 of the distribution network and/or consumption points at which one or several consumers are branched.

The fluid network 1 further comprises n flow rate sensors 4, four in number in this case, disposed at some pipes 2, as well as m pressure sensors 5, six in number in this case, disposed at some nodes 3. Each flow rate sensor 4 allows measuring the flow rate passing through the pipe 2 on which it is provided. Each pressure sensor 5 allows for its part measuring the pressure prevailing at the level of the node 3 on which it is provided.

At least one flow rate sensor 4a is provided at the inlet of the fluid network 1, in this case just at the outlet of a water tower 6. Some flow rate sensors 4b also allow dividing the network 1 into several sectors S1, S2, S3, in this case three sectors. Each sector S1, S2, S3 thus groups together a plurality of pipes 2 and nodes 3 and has a flow rate sensor 4b at each inlet or outlet of the sector S1, S2, S3. Although not represented here, some flow rate sensors may also be provided within a given sector. Thus, in addition to the flow rate sensors 4b present at the interfaces of the sectors S1, S2, S3, each sector S1, S2, S3 comprises at least one other hydraulic sensor, that is to say at least one other flow rate sensor 4 or at least one pressure sensor 5. In practice, thanks to the present method, it is possible to favor the installation of pressure sensors 5, which are less expensive than flow rate sensors.

Each sector S1, S2, S3 is also divided into several areas Z grouping together a few pipes 2 and a few nodes 3. Although only a few areas Z are represented in FIG. 1, it should be understood that all the pipes 2 of the network 1 belong to a well-defined area Z.

The fluid network 1 also has a leak characterization module 10 which may be hosted within a computer of the operating management of the fluid network 1 or within a remote server.

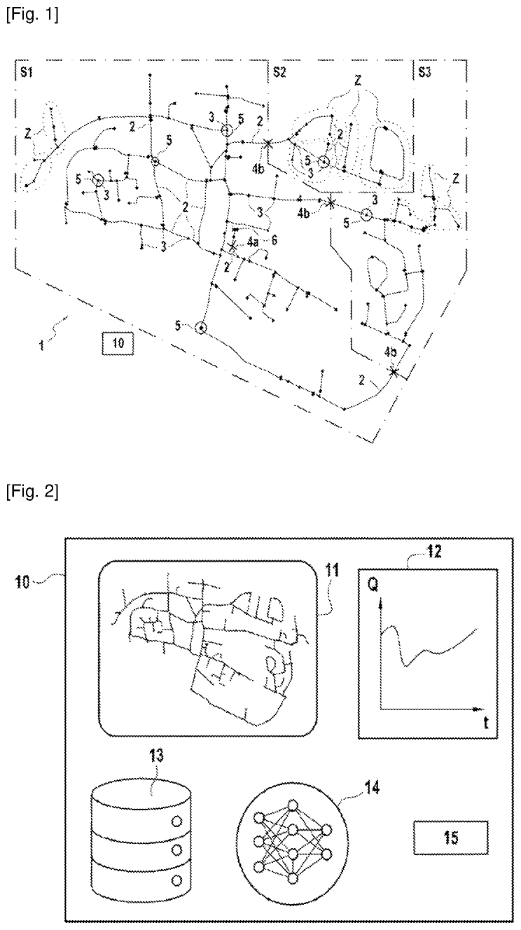

FIG. 2 illustrates the main elements of this leak characterization module 10. It thus comprises a digital mapping 11 of the fluid network 1, a digital model 12 of the hydraulic behavior of the network 1, a scenario database 13, a neural network 14 (forming a statistical learning model), and a calculation unit 15; it also comprises all the electronic elements that allow operating such an electronic module: power supply, user interfaces, memories, etc.

The digital mapping 11 comprises the geometry of the fluid network 1, that is to say the position, the orientation and the length of all the pipes 2, as well as the position of the whole equipment of the network, that is to say the valves, the junction collars, the connections, the valve boxes etc. The digital mapping 11 further comprises the location of all the hydraulic sensors 4, 5.

The digital model of the hydraulic behavior of the network 12 comprises theoretical flow rate values as a function of time for each pipe of the network 1 and theoretical pressure values as a function of time for each node 3 of the network 1; this digital model 12 therefore comprises particularly the estimated consumptions of each consumer of the network 1. Preferably, these theoretical values, mainly obtained based on past statistics, are estimated depending on the time of day, the day of week and the time of the year in order to approach as much as possible the real flow rate and pressure values of the network 1, whatever the moment considered.

The digital mapping 11 and the digital model 12 of the hydraulic behavior may be integrated within the same digital tool, for example of the Environmental Protection Agency Network Evaluation Tool (EPANET) type.

The database 13 for its part compiles as much scenarios as possible representing the most diverse possible situations that the network 1 may encounter. These situations may be real or simulated and may be with or without leaks. The construction of this database 13 is described in more detail below.

In the present example, the neural network 14 is an entirely connected convolutional network of the regressor type comprising three convolutional layers of time filters. The layers of the neural network 14 contain time filters of a size between 1 and 4 hours. The convolutional layers are organized such that the number of filters increases with the second layer, decreases with the last layer for the final estimation. To avoid the overlearning, the abandonment technique is used.

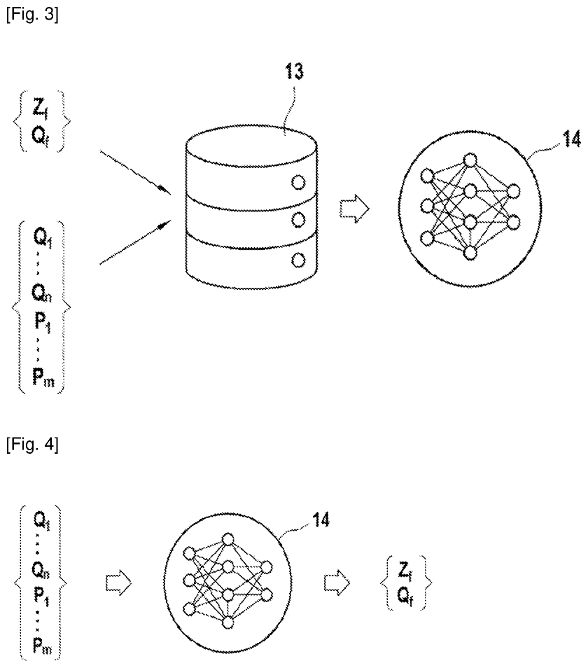

The calculation unit 15 may take the form of a processor: it is in particular programmed to be capable of carrying out hydraulic simulations, based on the digital mapping 11 and the digital model 12. The training of the neural network 14 is then represented in FIG. 3. A prior step to the training of the neural network 14 is the most extensive possible constitution of a scenario database 13, covering the most diverse possible scenarios. For each scenario, the database 13 records a time series of flow rate and pressure values, constituting hydraulic behavior data, for each of the hydraulic sensors 4, 5 of the network 1 and associates it with the leak data of the scenario in question, that is to say the area Zf and the flow rate Qf of each leak, or the “no leak” information when the scenario is a leak-free scenario. In the present example, the flow rate and pressure time series extend over 24 hours, from midnight to midnight, with a step of 15 minutes.

The database 13 first comprises a plurality of nominal leak-free consumption scenarios. These nominal consumption scenarios directly result from the digital model 12 of the hydraulic behavior for different times of the week and the year. Particularly, in the present example, the database 13 comprises at least nominal consumption scenarios for a working day and a weekend day, in the winter period on the one hand and in the summer period on the other hand. However, the greater the number of nominal consumption scenarios, the more efficient the training of the neural network 14: it is thus preferable to record different scenarios for each day of the week and each month of the year; it is also interesting to distinguish school holiday periods from the rest of the year.

In order to enhance the training of the neural network 14 and thus reduce the probability of false leak detection, the database 13 may also comprise leak-free robustness scenarios but comprising noise. In practice, these robustness scenarios may be derived from some nominal consumption scenarios in which variations are introduced in the requests of the different consumers. A nominal consumption scenario may thus lead to the generation of a plurality of robustness scenarios by introducing different variations from one robustness scenario to another. These variations comply with random draws according to given distribution laws, for example equally distributed laws, in given ranges of variations, these ranges of variations possibly depending on the type of consumer and/or seasonality.

The database 13 then comprises a plurality of leak scenarios, comprising one or more leaks. Some of these leak scenarios may result from real situations. Thus, for each real leak identified and characterized by an operator working on the network, all the data relating to this leak are recorded in the database 13: particularly, the characterization, comprising the area Zf with the leak and the leak flow rate Qf, is recorded in association with the flow rate Qi and pressure Pi time series measured by the hydraulic sensors 4, 5 over the period of time extending between the detection of the leak and its repair.

The greatest number of leak scenarios is however simulated from the digital mapping 11 and the digital model 12. The calculation unit 15 thus introduces into the mapping 11 an additional node 3, representing the simulated leak, in a given area Zf of the network 1 and assigns a flow rate Qf to it in the digital model 12. The calculation unit 15 then calculates based on the other parameters of the digital model 12 what would be the flow rate Qi and pressure Pi values measured by all the hydraulic sensors 4, 5 in such a situation. The thus simulated flow rate Qi and pressure Pi time series are then recorded in the database 13 in association with the data of the simulated leak, that is to say its area Zf and its flow rate Qf.

For a given area Zf and flow rate Qf, different simulations may be carried out for different days of the week or different times of the year, which increases the size and the diversity of the database 13.

The calculation unit 15 thus simulates a very large number of leak scenarios by successively browsing, for each day of the week and each time of the year, each area Z of the network and by incrementing, for each area Z, the leak flow rate Qf, for example by an equally distributed random draws from 0.1 m³/h to 20 m³/h.

In addition to single-leak scenarios, the database 13 also comprises multi-leak scenarios. The calculation unit 15 simulates such multi-leak scenarios similarly to what has been described above except that the calculation unit 15 in this case introduces several additional nodes 3 and assigns to each of them a leak flow rate Qf. The calculation unit thus browses in a matrix manner the leak areas Zf and the leak flow rates Qf for each of the thus simulated leaks.

These multi-leak scenarios may comprise an arbitrary number of leaks, this number being limited only by the computing power of the calculation unit 15 and by the time available to constitute the database 13. Reasonably, the database 13 comprises at least scenarios comprising up to three leaks.

Moreover, in order to increase the size of the database 13 and to enhance the training of the neural network 14, in particular with a view to greater robustness, each of these original scenarios, with or without a leak, may be multiplied by introducing stochastic variability in the time series of the consumer requests for each node of the network for each scenario, this variability then affecting the simulated flow rate and pressure time series. Thus, for each original scenario, with or without a leak, several scenarios may be recorded in the database 13 with different sets of stochastic offsets.

Once a large number of scenarios has thus been listed in the database 13, the neural network 14 uses the database 13 in order to perform its initial training. Once the initial training is over, the neural network 14 may then be used to automatically characterize new leaks.

Concretely, each day, the time series of flow rate Qi and pressure Pi values measured by the hydraulic sensors 4, 5 are recorded and compiled. As represented in FIG. 4, these flow rate Qi and pressure Pi time series are then transmitted at the inlet of the neural network 14: thanks to its training, the neural network 14 is then capable of determining whether the network 1 comprises one or several leaks and, in this case, characterizing each leak thus detected, that is to say its area Zf and its flow rate Qf.

The previous example has been described within the framework of a pre-existing network 1, consequently having pre-existing hydraulic sensors 4, 5 and a pre-established definition of the areas Z. However, in a first variant of embodiment, the leak characterization module 10 comprises an optimized sensor placement module configured to determine an optimized location for at least one new hydraulic sensor 4, 5. This optimized placement step is performed within a given sector S1, S2, S3.

This sensor placement module first defines several potential locations for a new sensor of a given type, for example for a pressure sensor 5. These potential locations may be arbitrary or decided manually or automatically based on the digital mapping 11 and on the digital model 12. Particularly, some portions of the network may be excluded because of too great technical or economic constraints to install a new sensor in this portion of the network. The sensor placement module thus forms several sets of sensors each including the existing sensors and a potential sensor positioned at the thus defined potential location.

The optimized sensor placement module then generates a large number of scenarios, with and without a leak, from the hydraulic behavior model 12: all these scenarios then form a reference set.

For each potential location of a new sensor, the optimized sensor placement module simulates, for each scenario of the reference set, the flow rate and/or pressure time series that would be measured by each existing sensor as well as by the new potential sensor; it then constructs for each potential location a sensitivity matrix comprising, for each leak scenario, the deviation measured by each sensor compared to the corresponding nominal leak-free scenario.

Once a sensitivity matrix has been thus constructed for each potential location, the optimized sensor placement module assigns points to each potential location as a function, on the one hand, of the number of leaks detected in the corresponding sensitivity matrix, that is to say the number of leak scenarios having effectively led to a notable deviation of the measurements of at least one sensor of the set tested compared to the corresponding nominal scenario; and as a function, on the other hand, of the number of leaks discerned from each other by the set of sensors, that is to say the number of leak scenarios having different signatures in the sensitivity matrix.

The optimized sensor placement module then classifies the potential locations according to the score obtained and thus proposes a selection of particularly promising locations for the placement of a new sensor.

In the example above, only one new sensor is envisaged. However, the optimized sensor placement module may similarly propose several new sensors simultaneously by generating sets of sensors including several potential sensors instead of just one.

Likewise, the previous example includes sensors already installed on the network. However, the optimized sensor placement module may similarly propose a completely new set of sensors, for example during the installation of a new network. In this case, the manipulated sets of sensors include only potential sensors and no existing sensors.

In a second variant of embodiment, which may or may not be combined with the first variant, the leak characterization module 10 also comprises a module for defining the areas Z of the fluid network 10 making it possible to define the areas Z of the network 1 in a more optimized manner, either initially, or within the framework of a redefinition of the areas Z. This area definition step is prformed within a given sector S1, S2, S3, and preferably within each sector S1, S2, S3.

The area definition module works once the set of sensors is known. It may be the set of existing sensors for a pre-existing network, or the set obtained by the method of the first variant above for a new network or for a network to be completed.

The area definition module then generates a large number of scenarios, with and without a leak, from the hydraulic behavior model 12: all of these scenarios then form a reference set. It may be the same reference set than the one used above for the placement of sensors.

The area definition module then simulates, for each scenario of the reference set, the flow rate and/or pressure time series that would be measured by each sensor of the set of sensors; it constructs a sensitivity matrix comprising, for each leak scenario, the deviation measured by each sensor compared to the corresponding nominal leak-free scenario. When the second variant is combined with the first variant, this sensitivity matrix is already constructed and may then be directly reused.

The area definition module then determines in the sensitivity matrix the groups of leaks which, for a given flow rate, are indiscernable from each other. The area definition module then defines each area Z of the sector such that each area Z groups together the locations of all the leaks that are indiscernable from each other. A set of minimum detectability areas is thus obtained for the considered set of sensors.

In a third variant of embodiment, which may be combined with the first variant and/or the second variant above, the leak characterization module 10 may also comprise a module for calibrating the digital model 12 of the hydraulic behavior, configured to adjust at least one parameter of the digital model 12 by comparing a simulated scenario with the corresponding real scenario. Such a calibration may in particular be carried out when the distribution network is modified or when evolutions in the consumption profiles are expected.

Such a calibration step is actually useful only in the presence of a significant error, for example greater than 10%, for at least one of the hydraulic behavior data between the scenario simulated with the digital model 12 and the corresponding real scenario. This calibration is carried out according to an optimization algorithm minimizing the error between the simulated data and the measured data.

Although the present disclosure has been described with reference to specific exemplary embodiments, it is obvious that modifications and changes can be made to these examples without departing from the general scope of the invention as defined by the claims. Particularly, individual characteristics of the different illustrated/mentioned embodiments can be combined in additional embodiments. Accordingly, the description and the drawings should be considered in an illustrative rather than restrictive sense.

It is also obvious that all the characteristics described with reference to a method can be transposed, alone or in combination, to one device, and conversely, all the characteristics described with reference to a device can be transposed, alone or in combination, to one method.

1. A method for training a statistical learning model intended for the characterization of a leak in a fluid network, the fluid network including several interconnected areas, wherein the fluid network is equipped with at least one flow rate sensor at the inlet of the fluid network and with at least one other hydraulic sensor, of the flow rate or pressure sensor type, configured to provide hydraulic behavior data, wherein the fluid network is provided with a digital mapping comprising at least the geometry of the fluid network and the location of said at least one flow rate sensor and said at least one other hydraulic sensor, the method comprising constructing a database containing:
a plurality of leak scenarios associating leak characterization data among a leak area and a leak flow rate with a set of hydraulic behavior data, and
a plurality of leak-free scenarios associating a “no leak” label with the set of hydraulic behavior data;
wherein the method further comprises training of the statistical learning model on the constructed database,
wherein the fluid network is provided with a digital model of the hydraulic behavior of the fluid network including at least one nominal consumption scenario, and
wherein the database contains at least one leak scenario simulated using the digital mapping of the fluid network and the digital model of the hydraulic behavior of the fluid network.

2. The training method according to claim 1, wherein the database contains at least several leak scenarios relating to different times of the day, days of the week and/or seasons.

3. The training method according to claim 1, wherein each scenario of the at least several leak scenarios includes at least one time series of sets of hydraulic behavior data, wherein the at least one time series extends over at least 4 hours.

4. The training method according to claim 3, wherein leak scenario includes several leaks, each having characterization data.

5. The training method according to claim 1, wherein the at least one other hydraulic sensor comprises at least one flow rate sensor and at least one pressure sensor, and wherein pressure sensors represent at least 50% of all sensors of the fluid network.

6. The training method according to claim 1, further comprising introducing a stochastic variability into the hydraulic behavior data recorded in the database for each leak scenario.

7. The training method according to claim 1, further comprising determining at least one optimized location for at least one new hydraulic sensor, the determining comprising the following:
simulating several potential hydraulic sensors at different locations in the fluid network;
simulating several leak scenarios; and
identifying potential sensors that maximize the probability of detection of the leaks and/or that maximize the discernibility of the detected leaks.

8. The training method according to claim 1, comprising a step of calibrating the digital model of the hydraulic behavior of the fluid network, during which at least one parameter of the digital model of the hydraulic behavior of the fluid network is adjusted by comparing a simulated scenario with the corresponding real scenario.

9. The training method according to claim 1, wherein the statistical learning model comprises at least one neural network.

10. A method for characterizing a leak in a fluid network, the fluid network including several interconnected areas, wherein the fluid network is equipped with at least one flow rate sensor at the inlet of the fluid network and with at least one other hydraulic sensor, of the flow rate or pressure sensor type, configured to provide hydraulic behavior data, wherein the fluid network is provided with a digital mapping comprising at least the geometry of the fluid network and the location of said at least one flow rate sensor and said at least one other hydraulic sensor, the method comprising:
receiving, by a statistical learning model as input, a set of hydraulic behavior data and
providing, by the statistical learning model, as output, leak characterization data among a leak area and a leak flow rate.

11. A module for characterizing a leak in a fluid network, the fluid network including several interconnected areas and being equipped with at least one flow rate sensor at the inlet of the fluid network and with at least one other hydraulic sensor, of the flow rate or pressure sensor type, configured to provide hydraulic behavior data, the fluid network being provided with a digital mapping comprising at least the geometry of the fluid network and the location of said flow rate sensor and the at least one other hydraulic sensor, the module comprising:
a statistical learning model, configured to receive as input, a set of hydraulic behavior data; and
the statistical learning model configured to provide, as output, leak characterization data among a leak area and a leak flow rate.

12. The module of claim 11, wherein the at least one other sensor is
configured to provide hydraulic behavior data.

13. (canceled)
